(19) United States
(12) Patent Application Publication
(10) Pub. No.: US 2009/0098427 A1
(43) Pub. Date: Apr. 16, 2009

(54) Fuel Cell Power Plant Diverting Air in Response to Low Demand

(76) Inventor: Carl A. Reiser, Stonington, CT (US)

Correspondence Address: M.P. Williams, 210 Main Street, Manchester, CT, 06042, US

(21) Appl. No.: 12/085,401

(22) PCT Filed: Nov. 29, 2005
(86) PCT No.: PCT/US05/43229

§ 371 Date: May 22, 2008

(51) Int. Cl. H01M 8/04

(52) U.S. Cl. 429/23

(57) ABSTRACT

A fuel cell system, which may be powering a vehicle propulsion system (159), includes a fuel cell power plant having a stack (151) including a plurality of fuel cells (12), each having a cathode (19) and anode (17) separated by a membrane (16), and an air pump (174) connected to reactant air flow fields through a diverter valve (172). A controller (185) is responsive to normal and high demand to cause the diverter valve to allow air to flow from the pump to the reactant air flow fields, and is responsive to low demand to cause said diverter valve to divert air directly into ambient so that it does not reach the cathode, thereby to reduce open circuit voltage conditions that promote degradation of the cathode, and to prevent excessive performance decay. An auxiliary load (220) can be in the diverted air flow, either ahead of or after the diverter valve. Energy storage (200, 201) works with the vehicle propulsion system.

### TECHNICAL FIELD

This invention relates to a fuel cell power plant, such as may be used to power an electric vehicle, in which rapid reduction of demand results in cathode air being diverted to ambient so as to avoid cathode dissolution and consequent severe performance decay.

### BACKGROUND ART

Polymer electrolyte, proton exchange membrane (PEM) fuel cell power plants with battery or capacity power augmentation typically have a very wide range in demand, the swings to very low demand causing open circuit voltage conditions. Under open circuit voltage conditions, the high relative cathode voltage causes cathode catalyst dissolution, which in turn results in excessive performance decay. Because such fuel cells also have sudden increases in power demand, the reactant air flow to the cathode must be available to meet such demand, and therefore the air pump must continue to operate during low demand in order to accommodate a quick resumption of a higher demand for power. It has been known to use a dummy load to absorb some of the excess fuel cell output power under these conditions so as to reduce the open circuit voltage and cathode corrosion.

### DISCLOSURE OF INVENTION

Objects of the invention include: controlling corrosion and performance decay in fuel cell stacks which supply power to electric or hybrid vehicles; conserving energy in a fuel cell power plant which is subject to repetitive low demand; controlling fuel cell reactions during reduced loads in a manner closely related to the then-present conditions; conserving otherwise wasted fuel and/or energy in a fuel cell power plant, reduction of open circuit voltage conditions in a fuel cell power plant having wide swings in demand; reduction of cathode catalyst dissolution in a fuel cell power plant having wide swings in demand; reducing performance decay in a fuel cell power plant subject to wide swings in demand; and improved fuel cell power plants.

This invention is predicated on recognition of the fact that a rapid and significant reduction in reactant air to the cathode of a fuel cell power plant, when it has a rapid swing to low power demand, significantly reduces the power dissipation required to hold the fuel cell stack at a safe voltage to avoid cathode degradation immediately following the reduction of demand. The invention is also predicated on recognition that if the cathode reactant pump, typically a blower, continues to run at nearly full operational speed, the power plant can respond quickly to a sudden increase in output power demand.

According to the invention, reactant air provided by a blower is rapidly diverted to ambient in response to low power demand that could result in high cathode voltage conditions such as greater than 0.85 volts per cell; the blower is run at a higher level than required during the low output power demand and is thus ready to respond to rapid increases in output power demand.

In further accord with the invention, an optional auxiliary load may be connected in parallel with the normal load whenever there is a rapid drop in output power demand, thereby dissipating the power which is generated in the process of consuming oxygen remaining in the stack, that is, residual oxygen in the flow fields and absorbed on the catalyst; the auxiliary load may be cooled by air from the blower during low demand.

Although some of the power resulting from consuming residual oxygen may be recovered by storage in a battery or capacitor bank, provided that the battery or capacitor bank is in a sufficiently discharged state to absorb the power, utilization of the invention avoids the situation where an energy storage system (battery or capacitors) has such a full charge that it cannot absorb any more energy during the rapid reduction of output power demand. In addition, fuel consumption is reduced during transition to low demand since the more rapid reduction of oxygen, due to the invention, quickly reduces the amount of power which the fuel cell power plant generates.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a schematic block diagram of a fuel cell power plant that diverts air from the cathodes during low demand, in accordance with the invention.

FIG. 2 is a schematic block diagram of a fuel cell power plant that dissipates the energy of a fuel cell stack in an auxiliary load during low demands, in accordance with the invention.

FIG. 3 is a schematic block diagram of an alternative to the embodiment of FIG. 2, according to the invention.

### MODE(S) FOR CARRYING OUT THE INVENTION

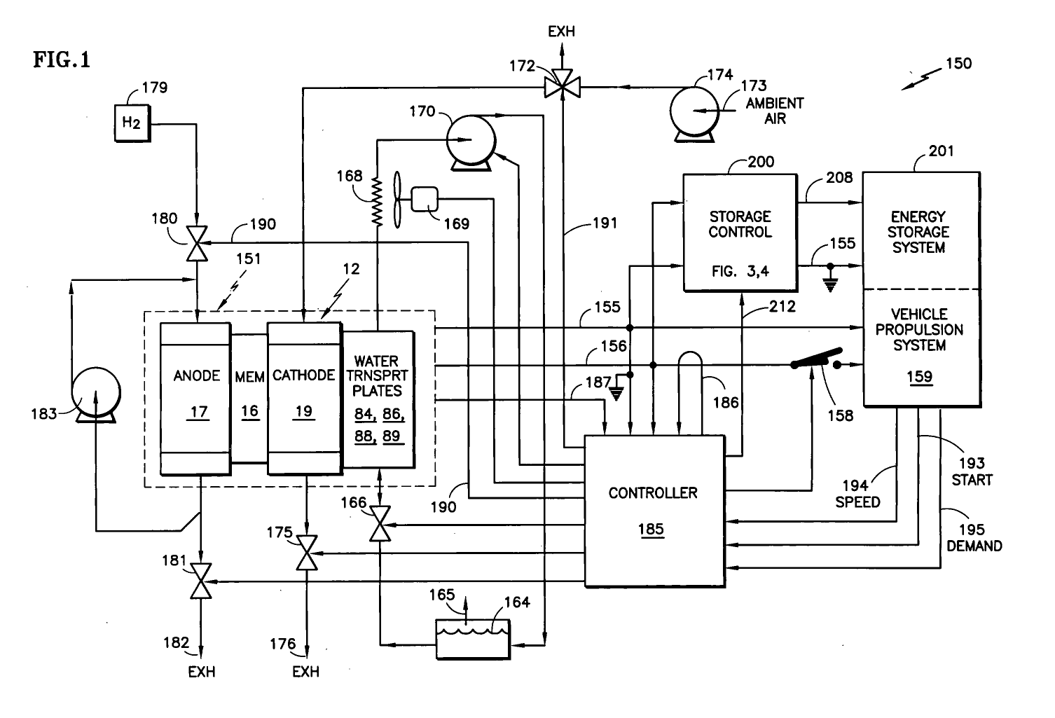

Referring now to FIG. 1, a vehicle 150 includes a fuel cell stack 151 comprising a plurality of contiguous fuel cells, each having a proton exchange membrane 16 between an anode 17 and a cathode 19, only one fuel cell 12 being shown in FIG. 1. The electrical output at the positive and negative terminals of the fuel cell stack 151 is connected by a pair of lines 155, 156 through a switch 158 to an electric or hybrid vehicle propulsion system 159.

A water circulation system has a reservoir 164 with a vent 165, a pressure control trim valve 166, water passages, such as those within water transport plates 84, 86, 88, 89, a radiator and fan 168, 169 which is selectively operable to cool water circulating in the system, and a water pump 170. Ambient air at an inlet 173 is provided by a pump, such as a blower 174, a compressor or the like through a two-way diverter valve 172 to the oxidant reactant gas flow fields of the cathode 19, and thence through a pressure regulating valve 175 to exhaust 176. Hydrogen is supplied from a source 179 through a flow regulating valve 180 to the fuel reactant gas flow fields of the anode 17, and thence through a purge valve 181 to exhaust 182. A fuel recycle loop includes a pump 183.

A controller 185 responds to load current determined by a current detector 186 as well as to the voltage across the lines 155, 156; it may also have temperature of the stack provided on a line 187. The controller, in turn, can control the valve 180 over a line 190 and the valve 172 over a line 191, as well as controlling the other valves, the switch 158, and the pumps 170, 174, as shown in FIG. 1.

The controller 185 responds to start, speed, and demand control signals from the vehicle propulsion system 159 on lines 193-195, which will indicate when the fuel cell should commence operation, and the amount of power being demanded by the vehicle propulsion system. Whenever a start signal is sent from the vehicle propulsion system 159 over the line 193 to the controller 185, signals from the controller will cause the valves 180, 181 and the pump 183 to be operated appropriately so as to provide fuel reactant gas to the flow fields of the anode 17, and the valves 172 and 175 as well as the pump 174 will be operated appropriately to provide ambient air to the flow fields of the cathode 19.

When fuel and air of sufficient quantity have been provided uniformly to the cells, open circuit voltage will be detected on the lines 155, 156 by the controller 185. At that time, the controller may close switch 158 so as to connect the fuel cell stack 151 to the vehicle propulsion system 159.

During startup or shutdown, a storage control 200 may dissipate the energy stored in the fuel cell stack by applying it to an energy storage system 201, which in the present embodiment is the battery of the vehicle propulsion system 159. In other embodiments, the energy storage system 201 may be some other battery, it may be a capacitor, or a flywheel, or it may be some other energy storage device. The energy storage 200, 201 may assist in providing or absorbing power during high or low demands, respectively, provided the current state of charge is appropriate.

In accordance with the invention, the two-way diverter valve 172 is adjusted to provide none, some or all of the air from the pump 174 to the oxidant reactant gas flow fields of the cathode 19. When the load demand drops to the point at which the fuel cells approach open circuit voltage, such as when the vehicle slows, stops or travels downhill, a signal from the controller on a line 191 adjusts the valve 172 to immediately divert some or all of the air to ambient. During low demand, the air pump may be operated at an air flow rate in excess of the flow required in the fuel cells so that the stack can respond quickly to increased demand. If desired in any given implementation of the invention, the controller may provide a signal on the line 191 as an inverse function of the load so that the diverter valve 172 diverts an appropriately proportional amount of air to ambient.

By utilizing the diverter valve 172 to dump the air, the pump 174 can remain running and the amount of air flowing to the cathode is reduced immediately so that only a small amount of residual air remains in the cathode flow fields and in the electrode structures. In some embodiments, the speed of the pump 174 may be reduced during low loads, or even stopped.

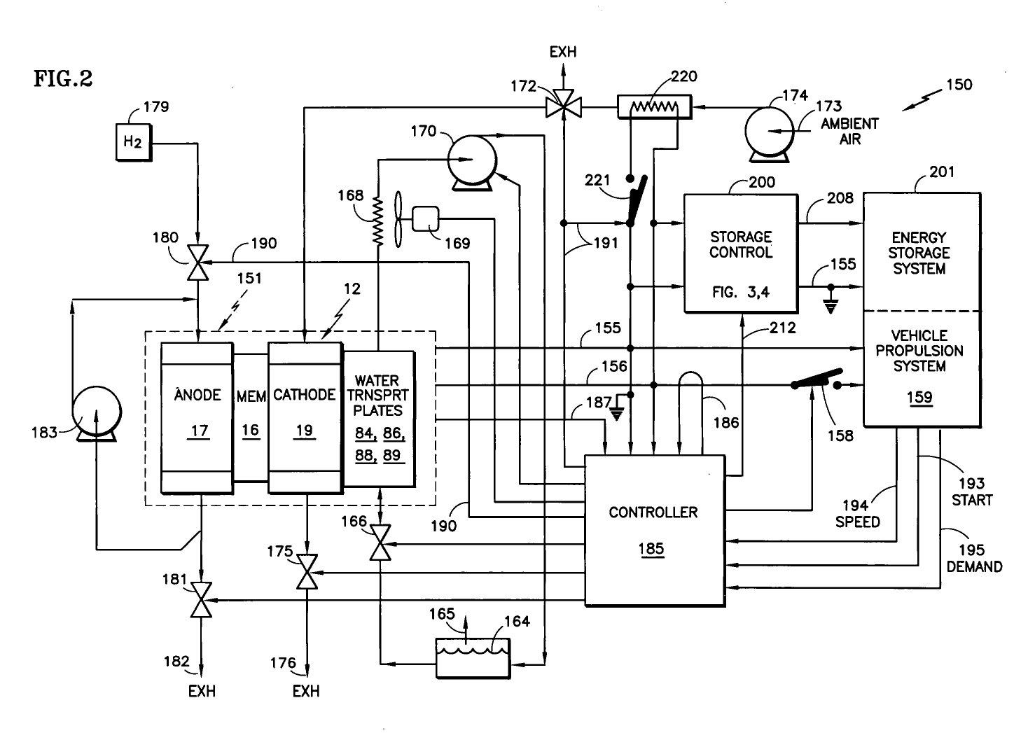

Optionally, the invention just described may be used in conjunction with a power dissipating auxiliary load 220 (FIG. 2) which is connected to the fuel cell output lines 155, 156 through a switch 221 by the controller, in response to the signal on the line 191 which opens the valve 172 in order to divert the flow of air to ambient. The auxiliary load 220 may be cooled by the air flow from the pump 174 as it passes to and through the diverter valve 172 to exhaust. This allows a greater dissipation of energy from the residual oxygen in the cathodes.

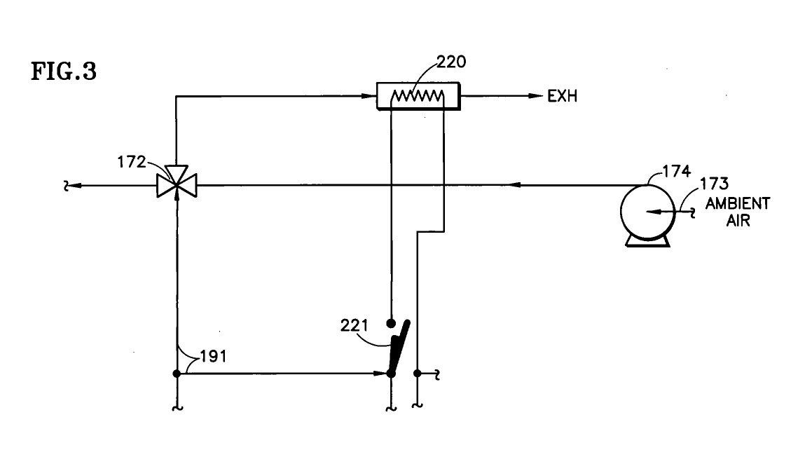

An alternative optional embodiment of the invention (FIG. 3) places the auxiliary load 220 downstream of the diverter valve 172 so that during normal operation, there is no pressure drop thereacross, but on the other hand, this embodiment will entail a less rapid change in the air flow to the cathodes due to a pressure drop across the auxiliary load 220. It is preferred that the physical location of the auxiliary load 220 is such that it is cooled by ambient air as well.

The invention may also be used in stationary and other types of power plants.

1. A fuel cell power plant comprising:
a fuel cell stack (151) including a plurality of fuel cells (12), each having a cathode (19) with a reactant air flow field and an anode (17) on opposite sides of a proton exchange membrane (16);
an air pump (174) connected to said air flow fields for providing reactant air to said cathodes; and
a load (159) powered by said stack;
characterized by:
a diverter valve (172) disposed between said air pump and said air flow fields (159, 200, 201) for selectively diverting air from said pump to ambient without diverted air passing through said air flow fields;
a controller (185) responsive to power demand (195) of said load to control said diverter valve in a manner to reduce the amount of air provided to said air flow fields in response to a reduction in power demand.

2. A fuel cell power plant according to claim 1 wherein:
said diverter valve (172) diverts all of the air from said pump (174) to ambient in response to low demand by said load (159).

3. A fuel cell power plant according to claim 1 wherein:
said diverter valve (172) is caused to divert a portion of the air from said pump (174) to ambient in relation to said demand by said load (159).

4. A fuel cell power plant according to claim 1 further characterized by:
an auxiliary load (220) connectable across the power output (155, 156) of said stack (151) in response to said controller (185) sensing low demand by said load.

5. A fuel cell power plant according to claim 4 wherein:
said auxiliary load (220) is disposed in a flow of air from said pump (174) between said pump and said diverter valve (172).

6. A fuel cell power plant according to claim 4 wherein:
said auxiliary load (220) is disposed in a flow of air from said pump (174) between said diverter valve (172) and ambient.

7. An electric or hybrid vehicle characterized by:
a fuel cell power plant according to claim 1 wherein:
said load is a vehicle propulsion system (159);
said controller (185) is responsive to voltage output (155, 156) and current output (186) of said fuel cell stack (151) as well as start (193), speed (194) and demand (195) signals from said vehicle propulsion system (159); and
said vehicle propulsion system is connectable (158) to said power output of said fuel cell stack by said controller (185) in response to said signals.

8. An electric vehicle according to claim 7 further characterized by:
an auxiliary load (220) connectable across the power output (155, 156) of said stack (151) by said controller (185) in response to said signals (155, 156; 186; 193-195) indicating low demand.

9. A fuel cell power plant according to claim 1 wherein:
the speed of said pump (174) is reduced in response to low demand from said load.

10. A fuel cell power plant according to claim 9 wherein:
said pump is stopped in response to low demand from said load.
